(19) United States
(12) Patent Application Publication
(10) Pub. No.: US 2017/0228148 A1
(43) Pub. Date: Aug. 10, 2017

(54) METHOD OF OPERATING INTERFACE OF TOUCHSCREEN WITH SINGLE FINGER

(71) Applicant: National Cheng Kung University, Tainan (TW)

(72) Inventors: Shuo-Fang Liu, Tainan (TW); Hsin-Hsi Lai, Tainan (TW); Ming-Hong Wang, Tainan (TW)

(21) Appl. No.: 15/233,286

(22) Filed: Aug. 10, 2016

(30) Foreign Application Priority Data
Feb. 4, 2016 (TW) 105103898

(51) Int. Cl. G06F 3/0488; G06F 3/0484

(52) U.S. Cl. CPC G06F 3/04883; G06F 3/04845

(57) ABSTRACT

A method of operating an interface of a touchscreen with a single finger, adapted to perform a rotation operation on a frame displayed on a touchscreen of an electronic device, the electronic device comprising a detection unit and a control unit, the method comprising the steps of: touching the touchscreen for a predetermined time period, wherein the detection unit defines a touch position as an initial action point; displaying a rotation operation interface on the frame by the control unit; sliding the frame from the initial action point for a predetermined distance, wherein the detection unit defines the slided position as a start action point; and sliding the frame clockwise or counterclockwise about the initial action point, followed by rotating the frame clockwise or counterclockwise under the control of the control unit.

### CROSS REFERENCE

This non-provisional application claims priority from Taiwan Patent application No. 105103898, filed on Feb. 4, 2016, the content thereof is incorporated by reference herein.

### BACKGROUND OF THE INVENTION

Field of the Invention

The present invention relates to methods of operating an interface of a touchscreen and, more particularly, to a method of operating an interface of a touchscreen of a mobile device with a single finger, thereby allowing users to operate an interface of a smart mobile device more intuitively and easily through integration of a human being, information, and the interface of the smart mobile device.

Description of the Prior Art

Human beings' physical strength, sensation, and cognitive functions decrease with age. With their sight, visual search capability, fine motor skills, finger dexterity, and tactile sensitivity deteriorating, the elderly are confronted with increasingly great difficulties in operating applications (apps) of mobile electronic devices.

Conventional touch gestures for performing a rotation operation on an interface of a touch smart mobile device are still carried out with at least two fingers. For example, a user puts any two fingers on a touchscreen of a touch smart mobile device and then turns the two fingers clockwise or counterclockwise across the touchscreen so that pictures displayed on the touchscreen are rotated clockwise or counterclockwise. If rotation graphical operations cannot be performed on the interface of a touch mobile device, it will be necessary to access a picture editing control level and then control the required rotation operations with a key in order to effectuate rotation.

Accordingly, it is imperative that the inventor of this application and related manufacturers overcome the aforesaid drawbacks of the prior art.

### SUMMARY OF THE INVENTION

In view of the aforesaid drawbacks of the prior art, the inventor of the present invention collected related data, gave comprehensive evaluative considerations thereto, carried out tests and corrections repeatedly according to the inventor's years of experience in the related industry, and finally devised a method of operating an interface of a touchscreen with a single finger as disclosed in the present invention.

It is an objective of the present invention to provide a method of operating an interface of a touchscreen of a mobile device with a single finger, with a view to allowing users to operate an interface of a smart mobile device more intuitively and easily through integration of a human being, information, and the interface of the smart mobile device.

In order to achieve the above and other objectives, the present invention provides a method of operating an interface of a touchscreen with a single finger, adapted to perform a rotation operation on a frame displayed on a touchscreen of an electronic device, the electronic device comprising a detection unit and a control unit, the method comprising the steps of: touching the touchscreen for a predetermined time period, wherein the detection unit defines a touch position as an initial action point; displaying a rotation operation interface on the frame by the control unit; sliding the frame from the initial action point for a predetermined distance, wherein the detection unit defines the slided position as a start action point; and sliding the frame clockwise or counterclockwise about the initial action point, followed by rotating the frame clockwise or counterclockwise under the control of the control unit.

In a preferred embodiment, the rotation operation is performed on a picture displayed on a touchscreen.

In a preferred embodiment, the predetermined time is 10˜30 ms.

In a preferred embodiment, the predetermined time is 20 ms.

In a preferred embodiment, the rotation operation interface is displayed on the frame and centered at the initial action point.

In a preferred embodiment, the frame is slided upward from the initial action point for a predetermined distance to reach the start action point.

In a preferred embodiment, the step of rotating the frame clockwise or counterclockwise under the control of the control unit further comprises playing a voice instruction related to the clockwise or counterclockwise rotation operation.

In a preferred embodiment, the step of rotating the frame clockwise or counterclockwise under the control of the control unit further comprises increasing or decreasing the contrast of the frame.

In a preferred embodiment, the step of rotating the frame clockwise or counterclockwise under the control of the control unit further comprises increasing or decreasing the brightness of the frame.

In a preferred embodiment, after the step of rotating the frame clockwise or counterclockwise under the control of the control unit, the control unit controls the rotation operation interface to disappear.

The present invention efficiently simplifies conventional ways of rotating a frame to enable the elderly to access browsing functions in a manner that meet the needs of the elderly.

The present invention improves conventional ways of using touch gestures to rotate a frame, as the present invention not only entails using only a single finger to provide a touch gesture for controlling the way the frame is browsed and rotated, but also distinguishes itself from the “drag to move” way of rotating a frame on the rotation operation interface of a smart mobile device. Hence, the present invention is conducive to the enhancement of user experience and ease of use among the elderly and the disabled.

The present invention not only meets the needs of technological research and development but is also in line with the trend of using smart mobile devices. The present invention provides a method of operating an interface of a touchscreen with a single finger to not only effectuate a graphical rotation technique of controlling a mobile device interface but also devise a novel interface operation mode. Therefore, the present invention enables users to operate an interface of a smart mobile device more intuitively and easily through integration of a human being, information, and the interface of the smart mobile device.

### BRIEF DESCRIPTION OF THE DRAWINGS

FIG. 1 is a flowchart of a method of operating an interface of a touchscreen with a single finger according to a preferred embodiment of the present invention;

FIG. 2 is a schematic view 1 of the method of operating an interface of a touchscreen with a single finger according to a preferred embodiment of the present invention;

FIG. 3 is a schematic view 2 of the method of operating an interface of a touchscreen with a single finger according to a preferred embodiment of the present invention;

FIG. 4 is a schematic view 3 of the method of operating an interface of a touchscreen with a single finger according to a preferred embodiment of the present invention;

FIG. 5 is a schematic view 4 of the method of operating an interface of a touchscreen with a single finger according to a preferred embodiment of the present invention; and

FIG. 6 is a schematic view 5 of the method of operating an interface of a touchscreen with a single finger according to a preferred embodiment of the present invention.

### DETAILED DESCRIPTION OF THE EMBODIMENTS

To achieve the aforesaid objective and benefit, the present invention is depicted with drawings and illustrate with preferred embodiments whereby the features and functions of the present invention are explained with reference to the technical means and structures used by the present invention with a view to allowing persons skilled in the art to fully understand the present invention.

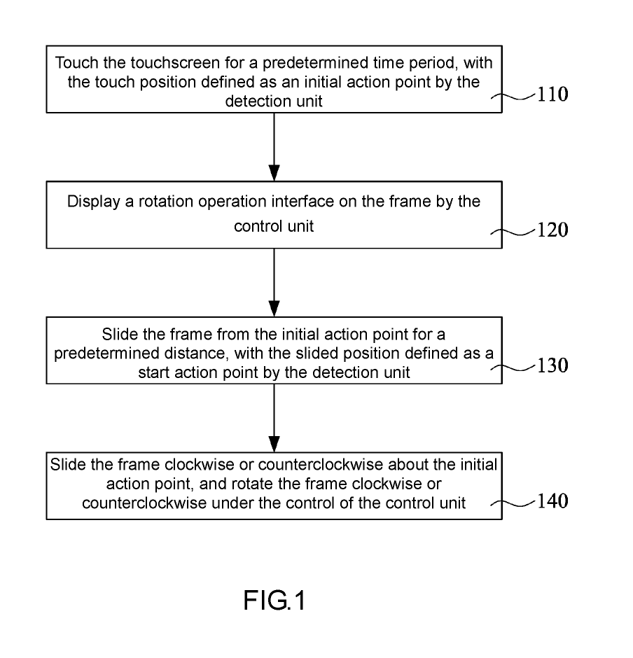

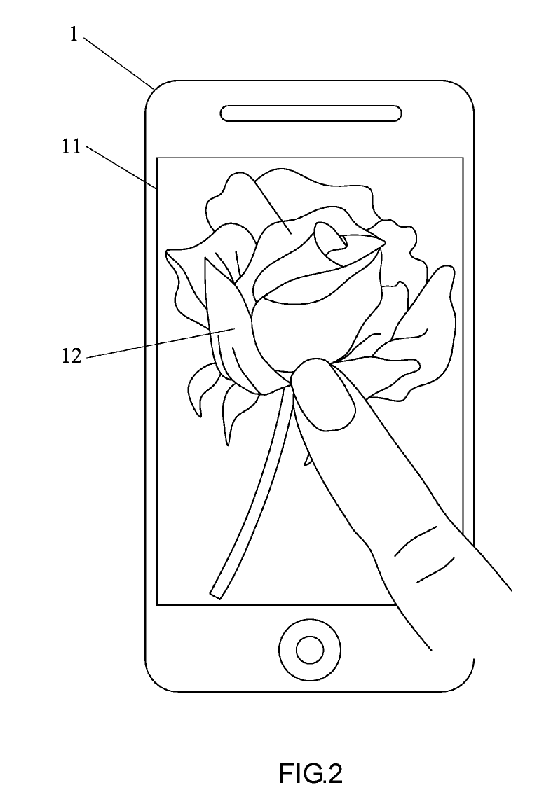

Referring to FIGS. 1 and 2, there are shown a flowchart and a schematic view 1 of a method of operating an interface of a touchscreen with a single finger according to a preferred embodiment of present invention, respectively. As shown in the diagrams, the present invention provides a method of operating an interface of a touchscreen with a single finger. By “a single finger,” it means that a user uses a single finger or a stylus to operate an interface of a touchscreen, but the present invention is not limited thereto. The method is for performing a rotation operation on a frame 12 shown on a touchscreen 11 of an electronic device 1. In this embodiment, the electronic device 1 is exemplified by a smart mobile device (such as a smartphone or a tablet), but the present invention is not limited thereto. The touchscreen 11 is the screen of the electronic device 1. The touchscreen 11 displays the frame 12. The electronic device 1 comprises a detection unit and a control unit. The detection unit detects positions of objects (such as a finger) on the touchscreen 11, whereas the control unit is, for example, a CPU of the electronic device 1, for receiving signals detected by the detection unit, analyzing as well as processing the signals, and performing related control operation. The method comprises steps as follows:

[step (110)] touching the touchscreen for a predetermined time period, wherein the detection unit defines the touch position as an initial action point; [step (120)] displaying a rotation operation interface on the frame by the control unit; [step (130)] sliding the frame from the initial action point for a predetermined distance, wherein the detection unit defines the slided position as a start action point; and [step (140)] sliding the frame clockwise or counterclockwise about the initial action point, followed by rotating the frame clockwise or counterclockwise under the control of the control unit.

With reference to the aforesaid structures and constituent design, the present invention is hereunder described in terms of use and operation. Referring to FIG. 2, there is shown a schematic view 1 of a method of operating an interface of a touchscreen with a single finger according to a preferred embodiment of the present invention. As shown in the diagram, the touchscreen 11 of the electronic device 1 displays a frame 12. In this embodiment, the frame 12 is a picture taken of a flower. A user touches the touchscreen 11 of the electronic device 1 with a single finger for the predetermined time period. The predetermined time period is 10˜30 ms, preferably 20 ms.

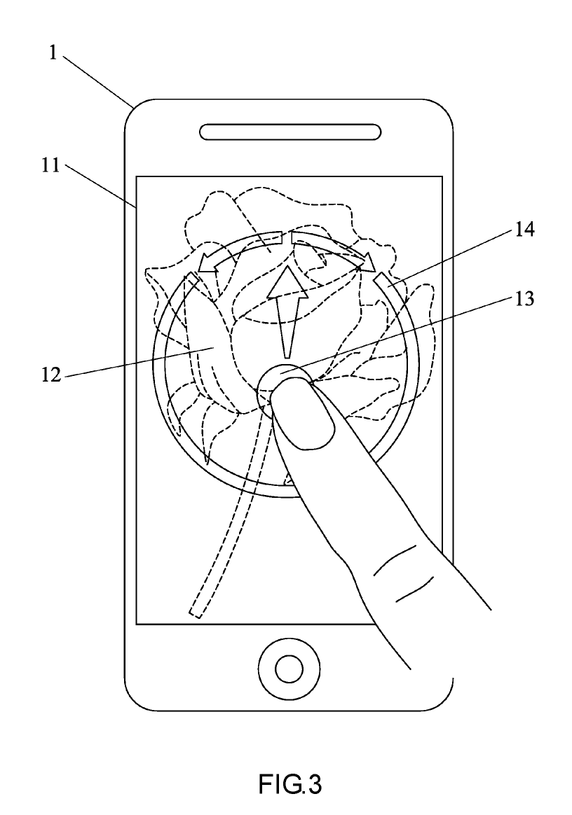

Referring to FIG. 3, there is shown a schematic view 2 of the method of operating an interface of a touchscreen with a single finger according to a preferred embodiment of the present invention. After the user has touched the touchscreen 11 of the electronic device 1 with a single finger for the predetermined time period, the detection unit defines the touch position, where the user touches the touchscreen 11 with a single finger, as an initial action point 13. The control unit of the electronic device 1 controls the frame 12 to display the rotation operation interface 14. In this embodiment, the rotation operation interface 14 is displayed on the frame 12 and centered at the initial action point 13. As shown in the diagram, an upward arrow is displayed on the rotation operation interface 14 and above the initial action point 13, wherein rightward and leftward arrows are shown above the upward arrow.

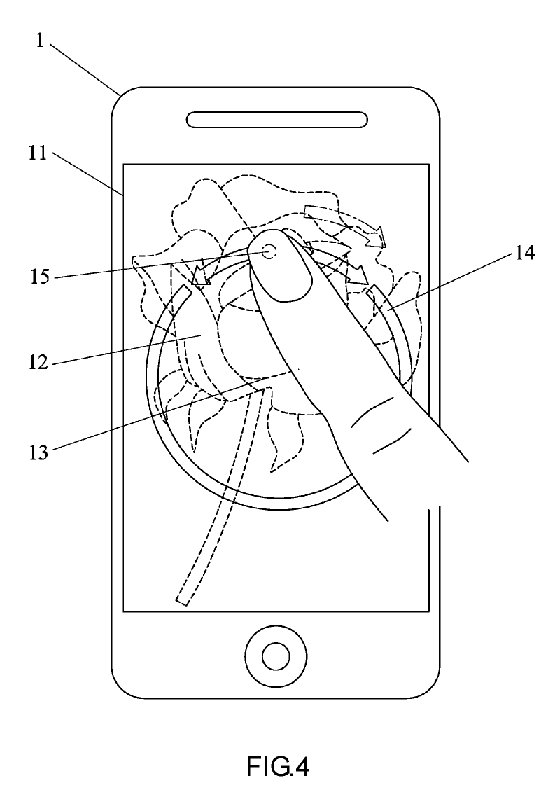

Referring to FIG. 4, there is shown a schematic view 3 of the method of operating an interface of a touchscreen with a single finger according to a preferred embodiment of the present invention. The user follows the instruction of the rotation operation interface 14 to slide the frame upward from the initial action point 13 for the predetermined distance. Alternatively, the slide is downward or in the other directions. The detection unit defines the slided position as a start action point 15. At this point in time, the user may decide whether to rotate the frame 12 clockwise or counterclockwise.

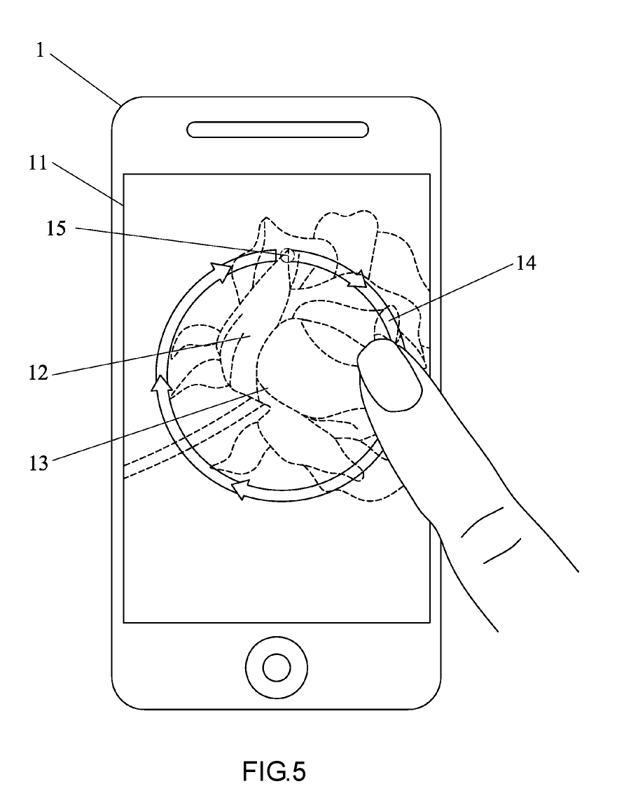

Referring to FIG. 5, there is shown a schematic view 4 of the method of operating an interface of a touchscreen with a single finger according to a preferred embodiment of the present invention. The user slides and rotates the frame 12 clockwise from the start action point 15 and about the initial action point 13 so that the control unit controls the frame 12 to rotate clockwise. Furthermore, the user slides and rotates the frame 12 counterclockwise about the initial action point 13 so that the control unit controls the frame 12 to rotate counterclockwise.

The clockwise or counterclockwise rotation of the frame 12 under the control of the control unit is further accompanied by the playing of a voice instruction related to the clockwise or counterclockwise rotation operation. For example, the control unit controls the electronic device 1 to play the voice instruction “rotate clockwise” or “rotate counterclockwise.” Alternatively, the clockwise or counterclockwise rotation of the frame 12 under the control of the control unit is further accompanied by increasing or decreasing the contrast of the frame 12 and even increasing or decreasing the brightness of the frame 12. Similarly, the control device controls the electronic device 1 to play the voice instruction “increase contrast,” decrease contrast,” “increase brightness,” or “decrease brightness.”

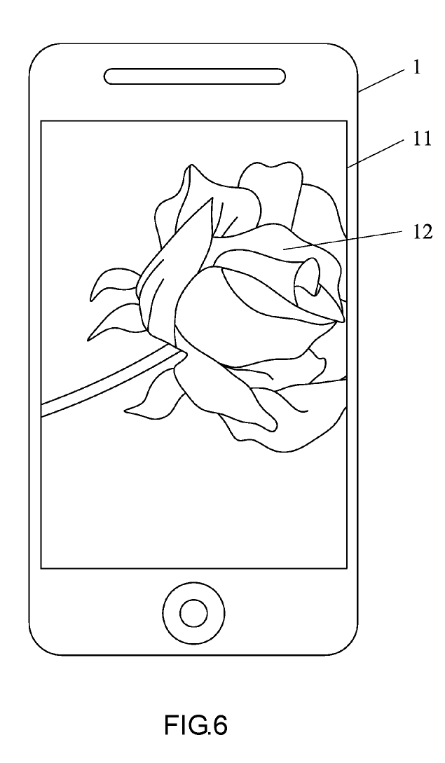

Referring to FIG. 6, there is shown a schematic view 5 of the method of operating an interface of a touchscreen with a single finger according to a preferred embodiment of the present invention. After the control unit has controlled the frame 12 to rotate clockwise or counterclockwise, the control unit controls the rotation operation interface 14 to disappear.

The method of the present invention integrates with an application (mobile app) of the electronic device 1 so that the way of browsing and rotating a frame with a single finger is controlled by programming. The aforesaid operation mode of the present invention is innovative and can be easily understood and implemented so that user can intuitively use a single finger to control a frame to rotate the direction of browsing a picture. Related techniques disclosed according to the present invention can be extensively applied to smart mobile device interfaces.

Referring to the drawings, compared with the prior art, the present invention in operation has advantages as follows: a method of operating an interface of a touchscreen with a single finger according to the present invention enables users to operate smart mobile device interfaces more intuitively and conveniently and thus is more suitable for the elderly, the handicapped, and the disabled.

The present invention is disclosed above by preferred embodiments. However, persons skilled in the art should understand that the preferred embodiments are illustrative of the present invention only, but should not be interpreted as restrictive of the scope of the present invention.

Hence, all simple modifications and equivalent structural changes made to the aforesaid embodiments according to the disclosure contained in the specification and drawings of the present invention should fall within the scope of the claims of the present invention.

What is claimed is:

1. A method of operating an interface of a touchscreen with a single finger, adapted to perform a rotation operation on a frame displayed on a touchscreen of an electronic device, the electronic device comprising a detection unit and a control unit, the method comprising the steps of:
touching the touchscreen for a predetermined time period, wherein the detection unit defines a touch position as an initial action point;
displaying a rotation operation interface on the frame by the control unit;
sliding the frame from the initial action point for a predetermined distance, wherein the detection unit defines the slided position as a start action point; and
sliding the frame clockwise or counterclockwise about the initial action point, followed by rotating the frame clockwise or counterclockwise under control of the control unit.

2. The method of operating an interface of a touchscreen with a single finger according to claim 1, wherein the rotation operation is performed on a picture displayed on a touchscreen.

3. The method of operating an interface of a touchscreen with a single finger according to claim 1, wherein the predetermined time period is 10˜30 ms.

4. The method of operating an interface of a touchscreen with a single finger according to claim 3, wherein the predetermined time period is 20 ms.

5. The method of operating an interface of a touchscreen with a single finger according to claim 1, wherein the rotation operation interface is displayed on the frame and centered at the initial action point.

6. The method of operating an interface of a touchscreen with a single finger according to claim 1, wherein the frame is slided upward from the initial action point for a predetermined distance to reach the start action point.

7. The method of operating an interface of a touchscreen with a single finger according to claim 1, wherein the step of rotating the frame clockwise or counterclockwise under control of the control unit further comprises playing a voice instruction related to the clockwise or counterclockwise rotation operation.

8. The method of operating an interface of a touchscreen with a single finger according to claim 1, wherein the step of rotating the frame clockwise or counterclockwise under control of the control unit further comprises increasing or decreasing contrast of the frame.

9. The method of operating an interface of a touchscreen with a single finger according to claim 1, wherein the step of rotating the frame clockwise or counterclockwise under control of the control unit further comprises increasing or decreasing brightness of the frame.

10. The method of operating an interface of a touchscreen with a single finger according to claim 1, wherein, after the step of rotating the frame clockwise or counterclockwise under control of the control unit, the control unit controls the rotation operation interface to disappear.
